(19) United States
(12) Patent Application Publication
(10) Pub. No.: US 2012/0286665 A1
(43) Pub. Date: Nov. 15, 2012

(54) LIGHTING DEVICE, LAMP AND METHOD FOR LIGHTING THE SAME

(75) Inventors: Horng-Jou WANG, Taoyuan County (TW); Shao-Yu CHEN, Taoyuan County (TW); Wen-Chia LIAO, Taoyuan County (TW); Li-Fan LIN, Taoyuan County (TW)

(73) Assignee: DELTA ELECTRONICS, INC., Taoyuan County (TW)

(21) Appl. No.: 13/467,203

(22) Filed: May 9, 2012

(30) Foreign Application Priority Data
May 13, 2011 (TW) 100116845

(51) Int. Cl. H01J 1/62; H01J 7/24

(52) U.S. Cl. 315/113; 315/312

(57) ABSTRACT

A lighting device includes a lighting engine and at least a wavelength-converting element. The lighting engine includes a circuit board, a blue light emitting diode and a red light emitting diode. The blue light emitting diode and a red light emitting diode are disposed on the circuit board. The wavelength-converting element covers at least the blue light emitting diode. A wavelength-converted light is generated by converting a part of light emitted by the lighting engine through the wavelength-converting element. White light having a color temperature within a range from 2580K to 3220K on the black-body radiation of the CIE-1931 chromaticity diagram is generated by mixing the wavelength-converted light and non-converted light emitted by the lighting engine.

### CROSS-REFERENCE TO RELATED APPLICATION

This application is based on and claims the benefit of Taiwan Application No. 100116845 filed May 13, 2011 the entire disclosure of which is incorporated by reference herein.

### BACKGROUND

1. Technical Field

The present disclosure relates to a lighting device, a lamp and a lighting method.

2. Description of Related Art

Light emitting diode (LED) is a solid state device generally made of compound semiconductor material for converting electrical energy to light. LEDs have the advantages of long lifetime, high stability and low power consumption. LEDs are initially employed in indication, traffic sign and sign board applications, and then gradually applied to general lighting applications as white LEDs are successfully developed.

A white LED known to the inventor(s) is made by coating yellow Yttrium aluminum garnet (YAG) phosphor over a blue LED chip. A part of light emitted from the blue LED chip is absorbed by the YAG phosphor, and then the YAG phosphor responsively generates wavelength-converted light. The wavelength-converted light, which is yellow light, is mixed with the non-converted light of the blue LED chip to generate white light.

The white LED manufactured by above-mentioned approach has a relatively high color temperature (cold white light) because non-converted light of the blue LED chip occupies a dominant part in the spectrum of the white LED.

To reduce the color temperature, red phosphor is added in the yellow YAG phosphor of the above-mentioned white LED. The red phosphor absorbs blue light and emits red light. The red light is mixed with the original white light with a relatively high color temperature to generate white light with a lower color temperature (warm white light).

The inventor(s) had several observations as follows. The yellow phosphor might have difficulty to mix uniformly with red phosphor which might result in the above-mentioned red-phosphor-added white LED providing non-uniform illumination. The white LED has lower lighting efficiency because the blue light is additionally absorbed by the red phosphor, besides the yellow phosphor. Moreover, the conversion efficiencies of the yellow phosphor and the red phosphor tend to decay with the usage of the white LED. The white LED tends to exhibit a color temperature shift after a period of operation time.

### SUMMARY

Accordingly, the lighting device according to one aspect of the present invention comprises a lighting engine and at least one wavelength-converting element. The lighting engine comprises a circuit board, a blue light emitting diode (LED) and a red LED. The blue LED and the red LED are arranged on the circuit board. The wavelength-converting element covers at least the blue LED. A partial light emitted from the lighting engine is converted by the wavelength-converting element to generate a wavelength-converted light. The wavelength-converted light is mixed with a non-converted light of the lighting engine to generate a white light having a color temperature between 2580K and 3220K located on the black-body radiation of CIE-1931 chromaticity diagram.

Accordingly, the lighting method according to another aspect of the present invention comprises: turning on a lighting engine to emit a light with chromaticity within a region defined by color points (0.5745, 0.3370), (0.3420, 0.1796), (0.3075, 0.0839), and (0.6581, 0.2518) in CIE-1931 chromaticity diagram; and exciting a phosphor to emit a wavelength-converted light and mixing the wavelength-converted light with a non-converted light of the lighting engine to form a white light, wherein the white light has a color temperature within 2580K to 3220K located on the black-body radiation of CIE-1931 chromaticity diagram.

Accordingly, the lamp according to still another aspect of the present invention comprises a lighting engine, a wavelength-converting element, a shell and a heat sink module. The lighting engine comprises a circuit board, a first lighting element and a second lighting element, where the first lighting element and the second lighting element are arranged on the circuit board. The wavelength-converting element covers at least partial portion of the lighting engine. The shell is made of transparent material. The heat sink module is assembled with the shell such that the lighting engine and the wavelength-converting element are arranged between the shell and the heat sink module. The lamp emits a white light with a color temperature within 2580K to 3220K located on the black-body radiation of CIE-1931 chromaticity diagram.

### BRIEF DESCRIPTION OF DRAWINGS

FIG. 1 is a sectional view of a lighting device according to a first embodiment of the present invention.

FIG. 2 is a top view of a lighting engine of the lighting device according to the first embodiment of the present invention.

FIG. 3 is a sectional view along the line A-A in FIG. 2.

FIG. 4 is the CIE-1931 chromaticity diagram for the lighting engine in accordance with some embodiments of the present invention.

FIGS. 5-9 are circuit diagrams for the lighting device in accordance with some embodiments of the present invention.

FIG. 10 is a chromaticity diagram in accordance with ANSI C78.377-2008, in which the region corresponding to white light is divided into 8 blocks.

FIG. 11 is another circuit diagram for the lighting device in accordance with one or more embodiments of the present invention.

FIG. 12 is a sectional view of a lighting device according to a second embodiment of the present invention.

FIG. 13 is a top view of a lighting engine of the lighting device according to the second embodiment of the present invention.

FIG. 14 is the CIE-1931 chromaticity diagram for the lighting engine according to the second embodiment of the present invention.

FIG. 15 is a schematic diagram that demonstrates the light mixing in the lighting device according to some embodiments of the present invention.

### DETAILED DESCRIPTION

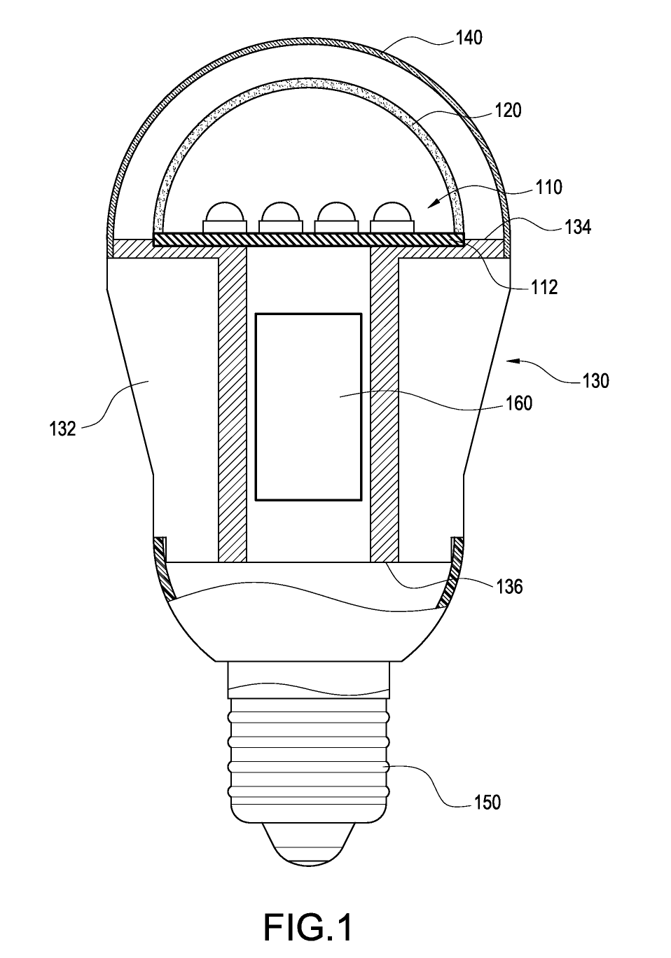

FIG. 1 is a sectional view of a lighting device 10 according to a first embodiment of the present invention. The lighting device 10 is, for example, a lamp for outdoor lighting. The lighting device 10 mainly comprises a lighting engine 110, a wavelength-converting element 120, a heat sink module 130, a cover 140, a conductive connector 150 and a driving circuit 160.

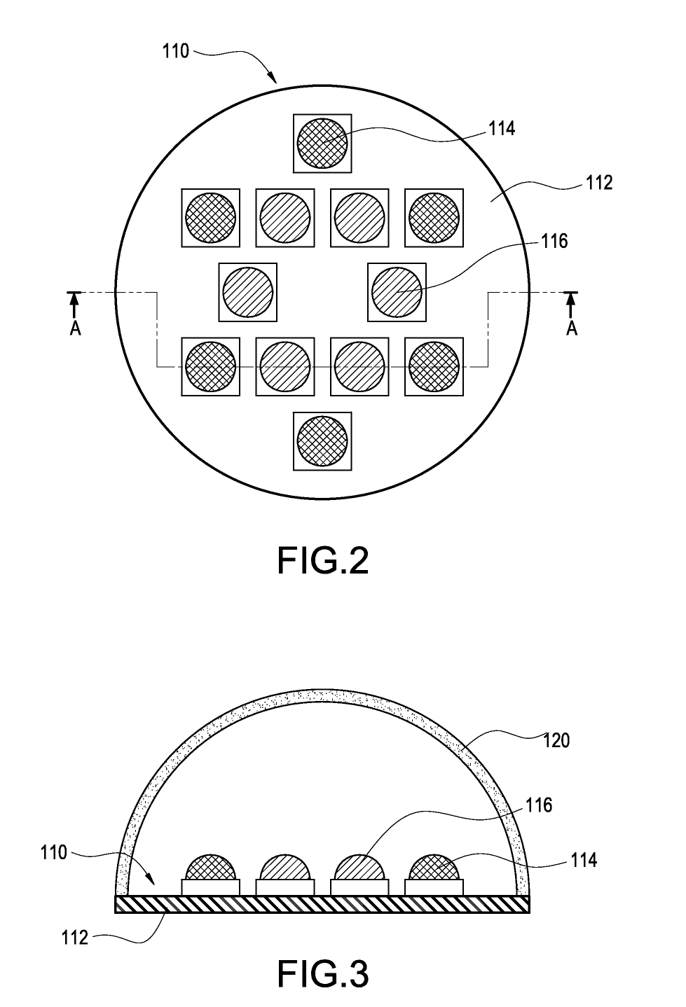

FIG. 2 is a top view of the lighting engine 110 according to the first embodiment of the present invention, and FIG. 3 is a sectional view along the line A-A in FIG. 2. The lighting engine 110 comprises a circuit board 112, a plurality of first light emitting elements 114 and a plurality of second light emitting elements 116. The circuit board 112 is, for example, a printed circuit board (PCB) and is provided with conductive traces (not shown) and soldering pads (not shown) thereon to mount the first light emitting elements 114 and the second light emitting elements 116. As shown in FIG. 2, the second light emitting elements 116 are substantially located at a center portion of the circuit board 112, and the first light emitting elements 114 encircle or surround the second light emitting elements 116. However, the above arrangement is only exemplary, and other arrangements are within the scope of the present disclosure. The first light emitting elements 114 are electrically connected to the second light emitting elements 116. Moreover, the first light emitting elements 114 are blue LEDs and the second light emitting elements 116 are red LEDs.

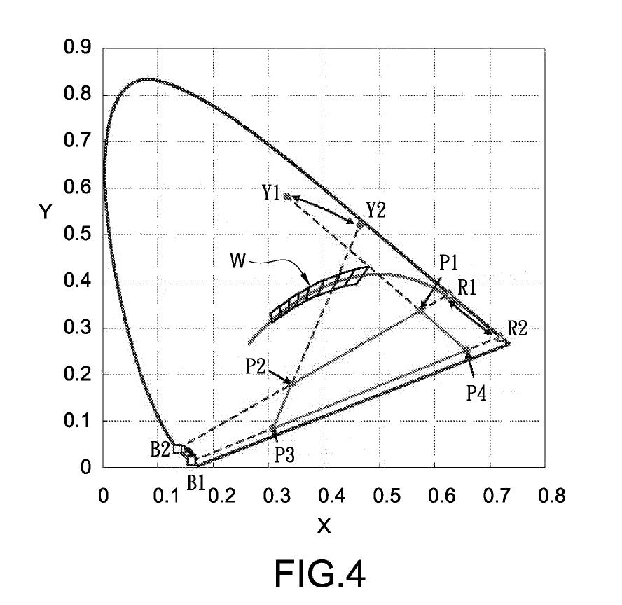

FIG. 4 is the CIE-1931 chromaticity diagram for the lighting engine in accordance with some embodiments of the present invention. The emitting wavelength of the first light emitting elements 114 is between 445 and 465 nm, which corresponds to the contour between color points B1 and B2. The emitting wavelength of the second light emitting elements 116 is between 600 and 640 nm, which corresponds to the contour between color points R1 and R2.

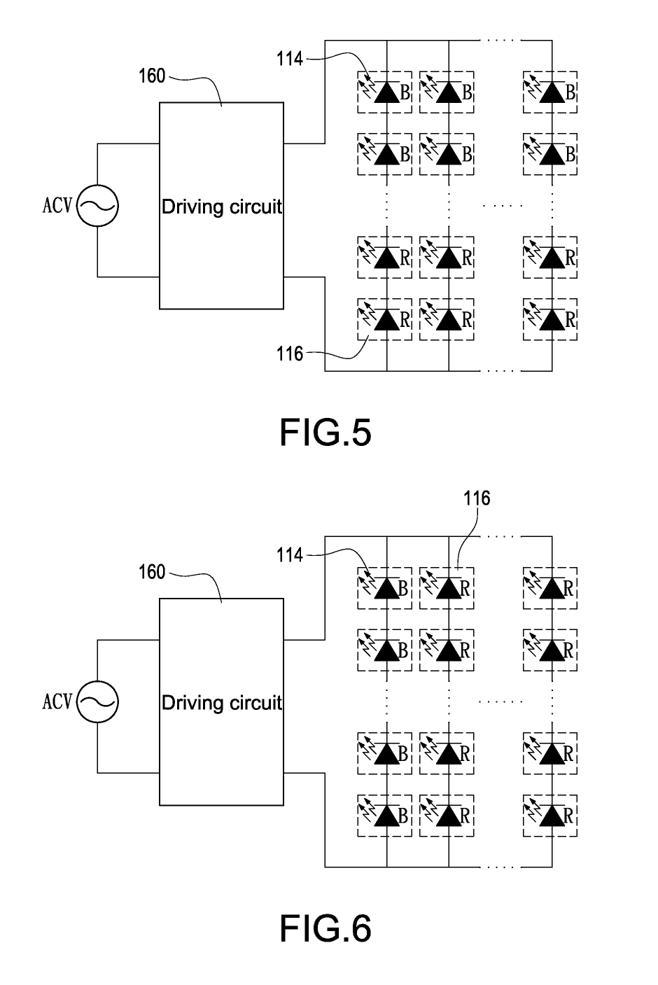

In one or more embodiments, each of the first light emitting elements 114 has a blue LED chip with a junction for emitting blue light, and the driving voltage range of each first light emitting element 114 is from 2.4 to 4 V. Each of the second light emitting elements 116 has a red LED chip with a junction for emitting red light, and the driving voltage range of each second light emitting element 116 is from 1.8 to 3.0 V. The first light emitting elements 114 and the second light emitting elements 116 are first connected in serial connection into one or more strings of mixed blue and red LED chips and then the strings are connected in parallel connection as shown in FIG. 5. The first light emitting elements 114 and the second light emitting elements 116 are electrically connected to the driving circuit 160, which is electrically connected to an alternating current source ACV. Alternatively, as shown in FIG. 6, the first light emitting elements 114 and the second light emitting elements 116 are first respectively connected in serial connection into one or more strings of blue LED chips and one or more strings of red LED chips, and then the strings are connected in parallel connection.

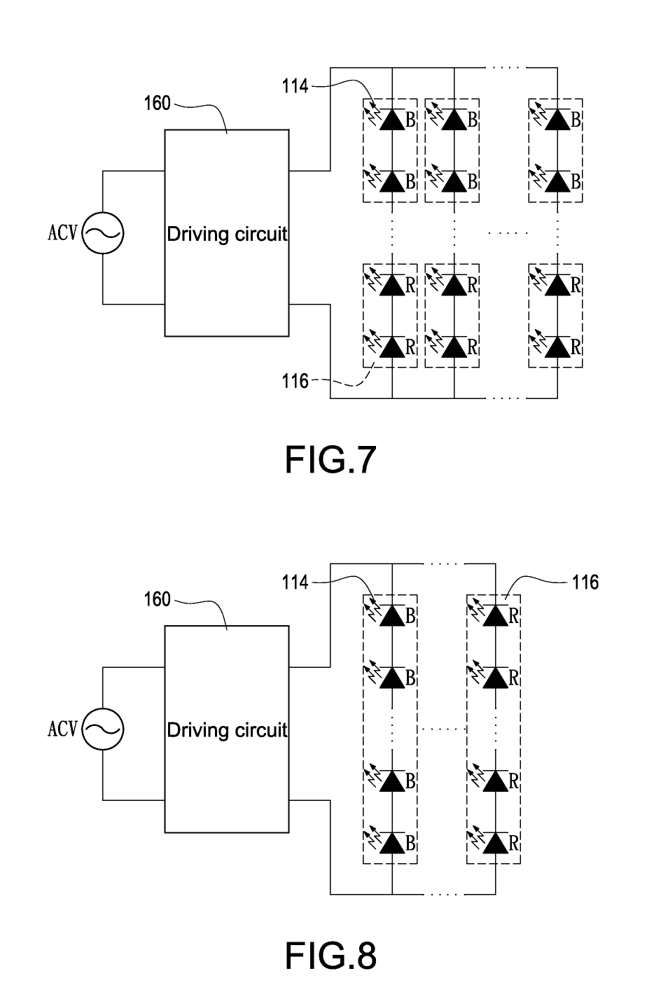

In one or more embodiments, each of the first light emitting elements 114 has a blue LED chip with multiple junctions each for emitting blue light, wherein the multiple junctions have one or more serial interconnections and/or parallel interconnections, e.g., by semiconductor process. Each of the second light emitting elements 116 has a red LED chip with multiple junctions each for emitting red light, wherein the multiple junctions have one or more serial interconnections and/or parallel interconnections, e.g., by semiconductor process. As shown in FIG. 7, the first light emitting elements 114 and the second light emitting elements 116 are connected in serial connection into one or more strings of mixed blue and red LED chips, and then the strings are connected in parallel connection. Alternatively, as shown in FIG. 8, the first light emitting elements 114 and the second light emitting elements 116 are respectively connected in serial connection into one or more strings of blue LED chips and one or more strings of red LED chips, and then the strings are connected in parallel connection. The first light emitting element 114 with multiple junctions has a driving voltage equal to M times of that for the first light emitting element 114 with a single junction, where M is the number of the multiple junctions in the first light emitting element 114. The second light emitting element 116 with multiple junctions has a driving voltage equal to N times of that for the second light emitting element 116 with a single junction, where N is the number of the multiple junctions in the second light emitting element 116.

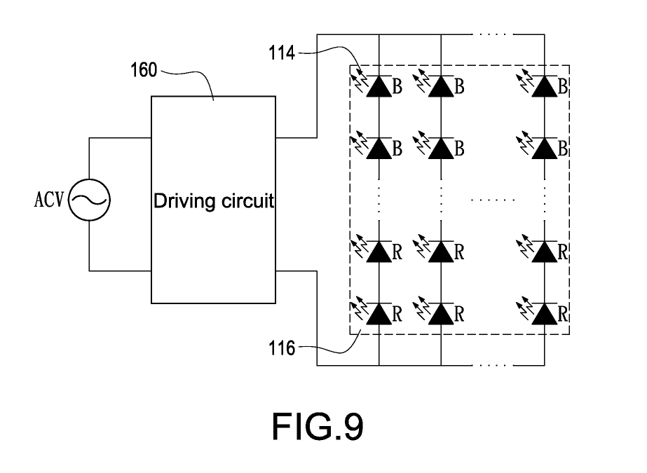

In one or more embodiments, each first light emitting element 114 has multiple blue LED chips, and each second light emitting element 116 has multiple red LED chips. The blue LED chips and the red LED chips are connected in serial and/or parallel connection, e.g., by packaging process, into a single package as shown in FIG. 9. Moreover, the first light emitting element 114 with multiple LED chips has a driving voltage equal to M times of that for the first light emitting element 114 with a single LED chip, where M is the number of the multiple LED chips in the first light emitting element 114. The second light emitting element 116 with multiple LED chips has a driving voltage equal to N times of that for the second light emitting element 116 with a single LED chip, where N is the number of the multiple LED chips in the second light emitting element 116.

With reference again to FIG. 3, the wavelength-converting element 120 at least covers the first light emitting elements 114 and comprises a transparent shell and at least one wavelength conversion material. The transparent shell can be formed by silicone, epoxy, mixture of silicone and epoxy, polymer material or other light transparent material. The wavelength conversion material is provided within the transparent shell and can be YAG phosphor, silicate phosphor, Terbium aluminum garnet (TAG) phosphor, oxide phosphor, nitride phosphor, aluminum oxide phosphor or other wavelength conversion phosphors or materials. The light emitted by the wavelength-converting element 120 after the wavelength-converting element 120 being excited corresponds to the contour between color points Y1 and Y2 shown in FIG. 4.

A part of light emitted from the lighting engine 110 is wavelength-converted in the wavelength-converting element 120 to generate wavelength-converted light. Another part of light emitted from the lighting engine 110 passes through the transparent shell without exciting the wavelength conversion material and is not wavelength-converted (non-converted). The wavelength-converted light is mixed with the non-converted light of the lighting engine 110 to form warm white light. As shown in FIG. 4, the thus-formed warm white light has a color temperature between 2580K and 3220K on the black-body radiation of the CIE-1931 chromaticity diagram, as marked by region W.

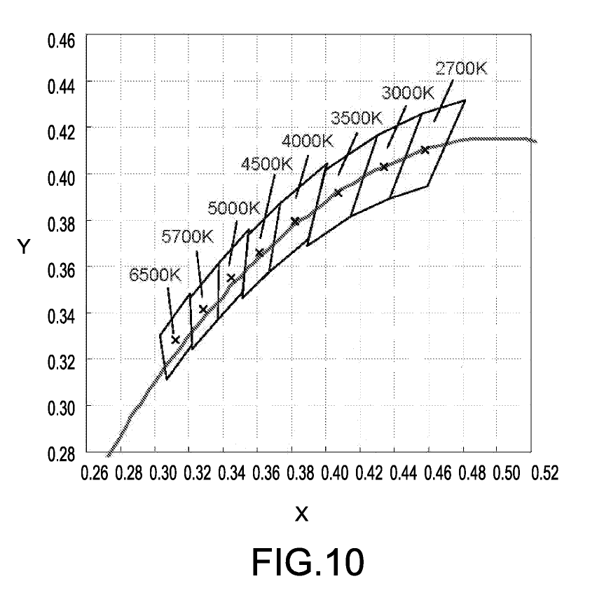

FIG. 10 is a chromaticity diagram in accordance with ANSI C78.377-2008 (“Specifications for the Chromaticity of Solid State Lighting Products”), in which the region corresponding to white light is divided into 8 blocks. The color temperatures associated with the 8 blocks are 2700K, 3000K, 3500K, 4000K, 4500K, 5000K, 5700K and 6500K. Moreover, the target correlated color temperature (CCT) and tolerance for those 8 blocks are 2725±145K, 3045±175K, 3465±245K, 3985±275K, 4503±243K, 5028±283K, 5665±355K and 6530±510K, respectively. In one or more embodiments of the present invention, the warm white light has a color temperature in the range between 2580K (2725-145K) and 3220K (3045+175K).

With reference again to FIG. 4, the color points Y1 and Y2, the color points B1 and B2 associated with the light emitted from first light emitting elements 114, and the color points R1 and R2 associated with the light emitted from the second light emitting elements 116 can determine an optimal chromaticity for the light emitted from the lighting engine 110. More particularly, the optimal chromaticity for the light emitted from the lighting engine 110, in accordance with some embodiments, corresponds to the region defined by the 4 color points P1 (0.5745, 0.3370), P2 (0.3420, 0.1796), P3 (0.3075, 0.0839), and P4 (0.6581, 0.2518) in the CIE-1931 chromaticity diagram. If the light emitted from the lighting engine 110 lies within the above-mentioned optimal chromaticity region, warm white light generated by mixing the light from the lighting engine 110 and the wavelength-converted light from the wavelength-converting element 120 is within the region W and has a color temperature between 2580K and 3220K.

With reference again to FIG. 1, the heat sink module 130 comprises a hollow casing 132 with a first side 134 and a second side 136 opposite to the first side 134. The circuit board 112 is arranged on the first side 134. The cover 140 is fixed to the first side 134 and encloses the lighting engine 110 and the wavelength-converting element 120 such that the lighting engine 110 and the wavelength-converting element 120 are arranged between the cover 140 and the heat sink module 130. The cover 140 can prevent dust from attaching to the wavelength-converting element 120 and prevent moisture from permeating into the circuit board 112, thus enhancing the light efficiency and prolonging the lifetime of the lighting device 10. The cover 140 can be made of light-transparent and/or light-scattering material.

The conductive connector 150 is arranged on the second side 136 of the heat sink module 130 and is adapted to be screwed into the socket of a lamp. The conductive connector 150 can be electrically connected to an AC power source, and can be an E26 or E27 connector.

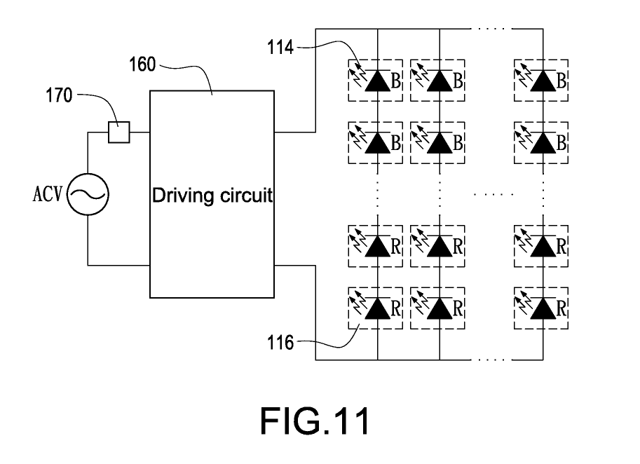

The driving circuit 160 is arranged within the heat sink module 130 and electrically connected to the lighting engine 110 and the conductive connector 150. With reference also to FIG. 11, the driving circuit 160 is functioned to convert AC power ACV input from the conductive connector 150 into DC power to drive the first light emitting elements 114 and the second light emitting elements 116 for illumination.

Moreover, the lighting device 10 further comprises a dimming controller 170 electrically connected to the driving circuit 160 and adapted to control the on/off operation and the brightness of the first light emitting elements 114 and/or the second light emitting elements 116.

The AC power supplied by the conductive connector 150 is converted into stable DC power by the driving circuit 160, and the lighting engine 110 is driven by the DC power. A part of the light of the lighting engine 110 is wavelength-converted by the wavelength-converting element 120 to form wavelength-converted light. White light having a color temperature from 2580K to 3220K on the black-body radiation of the CIE-1931 chromaticity diagram is generated by mixing the wavelength-converted light and non-converted light emitted by the lighting engine 110.

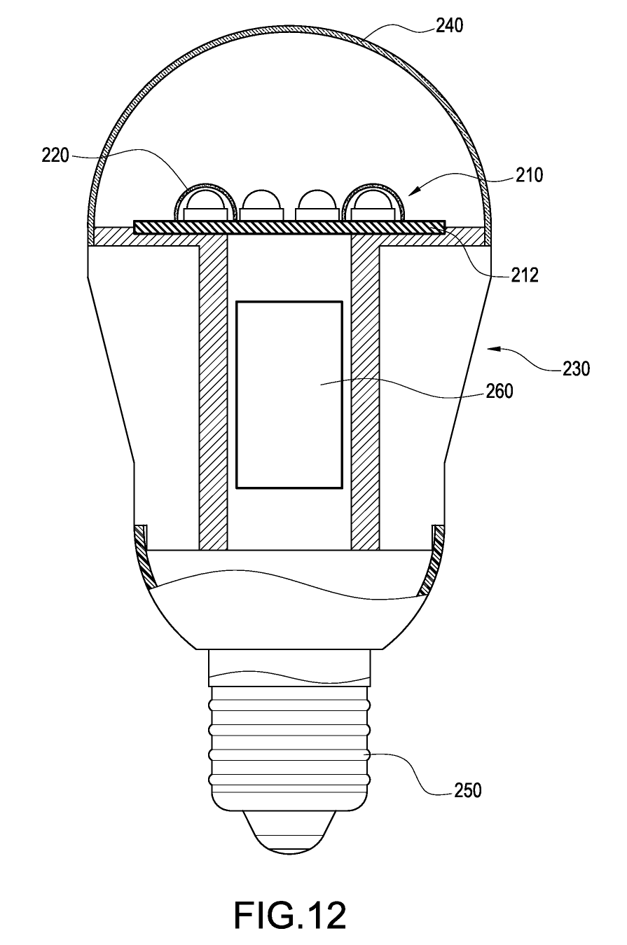

FIG. 12 is a sectional view of a lighting device 20 according to a second embodiment of the present invention. The lighting device 20 mainly comprises a lighting engine 210, a plurality of wavelength-converting elements 220, a heat sink module 230, a cover 240, a conductive connector 250 and a driving circuit 260.

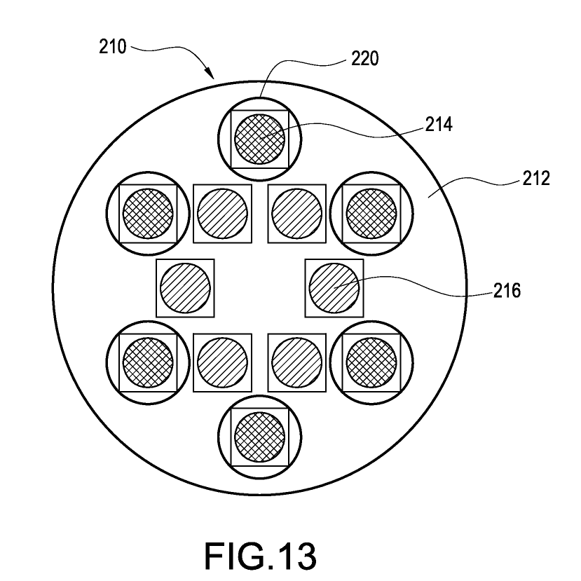

FIG. 13 is a top view of the lighting engine according to the second embodiment of the present invention. The lighting engine 210 comprises a circuit board 212, a plurality of first light emitting elements 214 and a plurality of second light emitting elements 216. The circuit board 212 is, for example, a printed circuit board (PCB) to mount the first light emitting elements 214 and the second light emitting elements 216. The first light emitting elements 214 are electrically connected to the second light emitting elements 216.

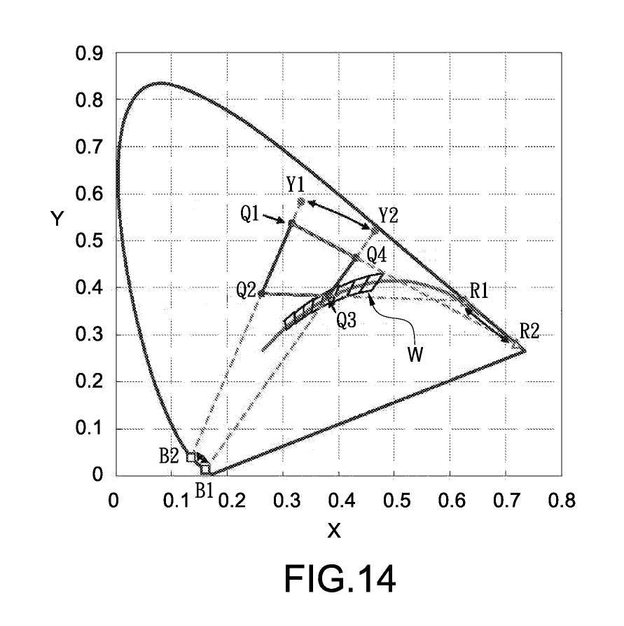

FIG. 14 is the CIE-1931 chromaticity diagram for the lighting engine according to the second embodiment of the present invention. The emitting wavelength of the first light emitting elements 214, which are blue LEDs, is 445 to 465 nm, which corresponds to the contour between color points B1 and B2. The emitting wavelength of the second light emitting elements 216, which are red LEDs, is 600 to 640 nm, which corresponds to the contour between color points R1 and R2.

With reference again to FIG. 12, the wavelength-converting elements 220 respectively enclose the corresponding first light emitting elements 214. Each of the wavelength-converting elements 220 comprises a transparent shell and a wavelength conversion material. The transparent shell can be formed by silicone, epoxy, mixture of silicone and epoxy, polymer material or other light transparent material. The wavelength conversion material is provided within the transparent shell and can be YAG phosphor, silicate phosphor, TAG phosphor, oxide phosphor, nitride phosphor, aluminum oxide phosphor or other wavelength conversion phosphors or materials. The light emitted by the wavelength-converting element 220 after the wavelength-converting element 120 being excited corresponds to the contour between color points Y1 and Y2 shown in FIG. 14.

A part of light emitted from the first light emitting elements 214 of the lighting engine 210 is wavelength-converted in the corresponding wavelength-converting elements 220 to generate wavelength-converted light. Another part of light emitted from the first light emitting elements 214 passes through the transparent shell without exciting the wavelength conversion material and is not wavelength-converted. The part of light emitted from the first light emitting elements 214 that is not wavelength-converted and the light emitted from the second light emitting elements 216 together define non-converted light. The wavelength-converted light is mixed with the non-converted light of the lighting engine 210 to form warm white light. The thus-formed warm white light has a color temperature within 2580K to 3220K on the black-body radiation of the CIE-1931 chromaticity diagram

To realize a lighting device 20 with warm white light having a color temperature between 2580K and 3220K, a part of light emitted from the first light emitting elements 214 is converted by the corresponding wavelength-converting elements 220, and mixed light formed by mixing the wavelength-converted light and the non-converted light of the first light emitting elements 214 and the second light emitting elements 216 corresponds to the region defined by the 4 color points Q1 (0.3162, 0.5367), Q2(0.2620, 0.3878), Q3(0.3822, 0.3827), and Q4 (0.4308, 0.4639) in the CIE-1931 chromaticity diagram, as shown in FIG. 14.

With reference again to FIG. 12, a cover 240 is provided to enclose the lighting engine 210 and the wavelength-converting elements 220. The cover 240 can prevent dust from attaching to the wavelength-converting elements 220 and prevent moisture from permeating into the lighting engine 210, thus enhancing the light efficiency and prolonging the lifetime of the lighting device 20. The cover 240 can be made of light-transparent and/or light-scattering material.

The heat sink module 230 is assembled with the cover 240 such that the lighting engine 210 and the wavelength-converting element 220 are arranged between the cover 240 and the heat sink module 230.

The conductive connector 250 is assembled to one side of the heat sink module 230, which is opposite to the cover 240. The conductive connector 250 is adapted to be screwed into the socket of a lamp. The conductive connector 250 can be electrically connected to an AC power source, and can be an E26 or E27 connector.

The driving circuit 260 is arranged within the heat sink module 230 and electrically connected to the lighting engine 210 and the conductive connector 250. The driving circuit 260 is functioned to convert AC power input from the conductive connector 250 into DC power to drive the lighting engine 210 for illumination.

The circuit of the lighting device of the second embodiment is similar to that of the first embodiment, and the detailed description thereof is omitted here for brevity.

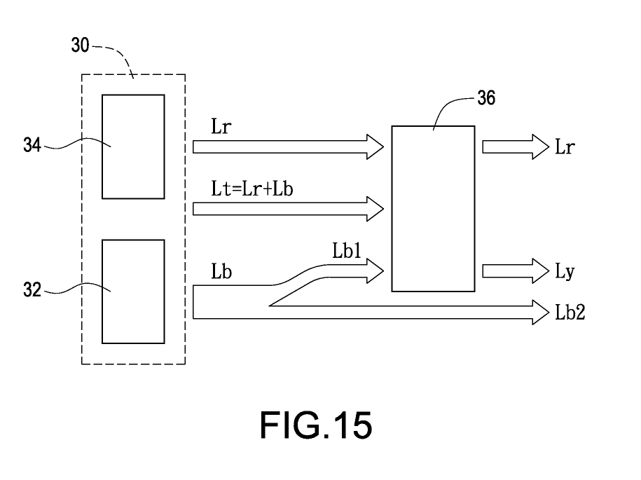

FIG. 15 is a schematic diagram that demonstrates the light mixing in the lighting device according to some embodiments of the present invention.

First, a lighting engine 30 is turned on. The lighting engine 30 comprises at least a blue LED 32 and at least a red LED 34. The blue LED emits blue light Lb with a wavelength between 445 to 465 nm, and the red LED emits red light Lr with a wavelength between 600 to 640 nm. The lighting engine 30 emits light Lt when it is turned on, where the light Lt is the mixture of the blue light Lb and the red light Lr. The chromaticity of the light Lt corresponds to the region defined by the 4 color points P1 (0.5745, 0.3370), P2 (0.3420, 0.1796), P3 (0.3075, 0.0839), and P4 (0.6581, 0.2518) in the CIE-1931 chromaticity diagram.

Afterward, the emitted light of the lighting engine 30 excites a wavelength conversion material, e.g., a phosphor 36, where the phosphor 36 can be YAG phosphor, silicate phosphor, Terbium aluminum garnet (TAG) phosphor, oxide phosphor, nitride phosphor, or aluminum oxide phosphor.

In the lighting engine 30, the blue LED 32 emits first blue light Lb1, which excites the phosphor 36 to generate wavelength-converted light Ly from the phosphor 36. Mixed light generated by mixing the wavelength-converted light Ly and second blue light (non-converted light) Lb2 has chromaticity corresponding to the region defined by the 4 color points Q1 (0.3162, 0.5367), Q2(0.2620, 0.3878), Q3(0.3822, 0.3827), and Q4 (0.4308, 0.4639) in the CIE-1931 chromaticity diagram. The blue light Lb includes the two portions, namely, the first blue light Lb1 and the second blue light Lb2.

The wavelength-converted light Ly is mixed with the non-converted light of the lighting engine 30 (including the second blue light Lb2 and the red light Lr) to form white light having a color temperature within 2580K to 3220K on the black-body radiation of the CIE-1931 chromaticity diagram.

To sum up, in some embodiments of the present invention, at least one red LED is employed to provide a red color portion in the warm white light generated by the lighting device. In comparison with known white light sources using red phosphor excited by a blue LED as a red light source, the lighting device in accordance with some embodiments has a higher efficiency, a lower likelihood of color temperature shift, and better color rendering property.

The first and/or second light emitting elements are not necessarily LEDs. For example, in one or more embodiments, first and/or second light emitting elements include one or more laser diodes, organic light-emitting diodes (OLED) or other light emitting devices.

The first and/or second light emitting elements do not necessarily emit blue and/or red light, and may be configured to emit light of other colors. In one or more embodiments, the first light emitting element is configured to emit light of a wavelength different from that of the second light emitting element. The wavelength-converting element is configured to be excited by the light emitted by at least one of the first or second light emitting elements to generate wavelength-converted light which is mixed with the non-converted light to provide light in a predetermined color temperature range.

Although several embodiments of the present invention have been described in detail, it will be understood that the disclosure is not limited to such details. Various substitutions and modifications will occur to those of ordinary skill in the art in light of the foregoing description. Therefore, all such substitutions and modifications are intended to be embraced within the scope of this disclosure.

1-25. (canceled)

26. A lighting device, comprising:
a lighting engine comprising a circuit board, a blue light emitting diode (LED) and a red LED, the blue LED and the red LED arranged on the circuit board; and
at least one wavelength-converting element covering at least the blue LED, for converting a part of light emitted from the lighting engine into wavelength-converted light, which is arranged to be mixed with non-converted light emitted from of the lighting engine to generate white light having a color temperature between 2580K and 3220K on the black-body radiation of the CIE-1931 chromaticity diagram.

27. The lighting device in claim 26, wherein the wavelength-converting element is configured to convert a part of light emitted by the blue LED into the wavelength-converted light, which is arranged to be mixed with non-converted light emitted from the blue LED to form mixed light having chromaticity within a region defined by color points (0.3162, 0.5367), (0.2620, 0.3878), (0.3822, 0.3827) and (0.4308, 0.4639) in the CIE-1931 chromaticity diagram.

28. The lighting device in claim 26, wherein the lighting engine is configured to generate light that has chromaticity within a region defined by color points (0.5745, 0.3370), (0.3420, 0.1796), (0.3075, 0.0839), and (0.6581, 0.2518) in the CIE-1931 chromaticity diagram.

29. The lighting device in claim 26, wherein the blue LED is configured to emit light with a wavelength between 445 and 465 nm.

30. The lighting device in claim 26, wherein the red LED is configured to emit light with a wavelength between 600 and 640 nm.

31. The lighting device in claim 26, wherein the wavelength-converting element comprises at least one transparent shell and at least one wavelength conversion material.

32. The lighting device in claim 31, wherein the wavelength conversion material is at least one selected from the group consisting of yttrium aluminum garnet (YAG) phosphor, silicate phosphor, terbium aluminum garnet (TAG) phosphor, oxide phosphor, nitride phosphor, and aluminum oxide phosphor.

33. The lighting device in claim 31, wherein the transparent shell is made of at least one selected from the group consisting of silicone, epoxy, mixture of silicone and epoxy, and polymer material.

34. The lighting device in claim 26, further comprising:
a heat sink module comprising a casing, the casing having a first side and a second side opposite to the first side;
a cover fixed to the first side of the heat sink module and enclosing the lighting engine and the wavelength-converting element;
a driving circuit arranged in the casing and electrically connected to the lighting engine; and
a conductive connector arranged on the second side of the heat sink module and electrically connected to the driving circuit.

35. The lighting device in claim 26, wherein
the lighting engine comprises a plurality of blue LEDs and a plurality of red LEDs electrically connected to the blue LEDs;
the red LEDs are located substantially at a center location of the circuit board, and the blue LEDs surround the red LEDs.

36. The lighting device in claim 26, wherein the wavelength-converting element covers both the blue LED and the red LED, and is configured to convert light emitted by the blue LED.

37. The lighting device in claim 26, wherein the wavelength-converting element covers the blue LED without covering the red LED, and is configured to convert light emitted by the blue LED.

38. The lighting device in claim 26, wherein
the lighting engine comprises a plurality of blue LEDs, and
the lighting device comprises a plurality of wavelength-converting elements each covering one of the blue LEDs and is configured to convert light emitted by the blue LED.

39. A lighting method, comprising:
turning on a lighting engine to emit light with chromaticity within a region defined by color points (0.5745, 0.3370), (0.3420, 0.1796), (0.3075, 0.0839), and (0.6581, 0.2518) in the CIE-1931 chromaticity diagram;
converting a part of the light emitted by the lighting engine into wavelength-converted light; and
mixing the wavelength-converted light with non-converted light, which is another part of the light emitted by the lighting engine, to form white light that has a color temperature between 2580K and 3220K on the black-body radiation of the CIE-1931 chromaticity diagram.

40. The method in claim 39, wherein the light emitted by the lighting engine includes blue light which has a part converted into the wavelength-converted light, and another part defining non-converted blue light, and the wavelength-converted light and the non-converted blue light are mixed to provide mixed light that has chromaticity within a region defined by color points (0.3162, 0.5367), (0.2620, 0.3878), (0.3822, 0.3827) and (0.4308, 0.4639) in the CIE-1931 chromaticity diagram.

41. The method in claim 40, wherein the blue light has a wavelength between 445 and 465 nm.

42. The method in claim 41, wherein the non-converted light of the light emitted by the lighting engine includes red light with a wavelength between 600 and 640 nm.

43. A lamp, comprising:
a lighting engine comprising a circuit board, a first lighting element for emitting light of a first wavelength and a second lighting element for emitting light of a second wavelength different from the first wavelength, the first lighting element and the second lighting element arranged on the circuit board;
a wavelength-converting element at least partially covering the lighting engine;
a shell made of transparent material;
a heat sink module assembled with the shell such that the lighting engine and the wavelength-converting element are arranged between the shell and the heat sink module;
wherein the lamp is configured to emit white light with a color temperature within a range from 2580K to 3220K on the black-body radiation of the CIE-1931 chromaticity diagram.

44. The lamp in claim 43, wherein the first wavelength is between 445 and 465 nm, and the second wavelength is between 600 and 640 nm.

45. The lamp in claim 43, wherein
the lighting engine is configured to emit light with chromaticity within a region defined by color points (0.5745, 0.3370), (0.3420, 0.1796), (0.3075, 0.0839), and (0.6581, 0.2518) in the CIE-1931 chromaticity diagram, and
the wavelength-converting element is configured to convert a part of the light emitted by the first lighting element into wavelength-converted light to be mixed with non-converted light, which is another part of the light emitted by the first lighting element, to generate mixed light having chromaticity within a region defined by color points (0.3162, 0.5367), (0.2620, 0.3878), (0.3822, 0.3827) and (0.4308, 0.4639) in the CIE-1931 chromaticity diagram.
